(19) United States
(12) Patent Application Publication
(10) Pub. No.: US 2012/0135228 A1
(43) Pub. Date: May 31, 2012

(54) LIQUID CRYSTALLINE POLYESTER COMPOSITION

(75) Inventors: Yoshiyuki FUKUHARA, Ibaraki (JP); Ryo MIYAKOSHI, Ibaraki (JP)

(73) Assignee: SUMITOMO CHEMICAL COMPANY, LIMITED, Tokyo (JP)

(21) Appl. No.: 13/305,890

(22) Filed: Nov. 29, 2011

(30) Foreign Application Priority Data
Nov. 30, 2010 (JP) 2010-266234

(51) Int. Cl. C09K 19/06

(52) U.S. Cl. 428/339; 252/299.6

(57) ABSTRACT

Disclosed is a liquid crystalline polyester composition which contains a liquid crystalline polyester and mica and which provides a molded article hard to form blisters therein under a high temperature condition, even when it is molded at a high temperature. The liquid crystalline polyester composition is prepared by incorporating the mica and a fluorocarbon polymer whose flow start temperature is 330° C. or lower into the liquid crystalline polyester. The content of the mica in the liquid crystalline polyester composition is preferably from 15 to 100 parts by mass per 100 parts by mass of the liquid crystalline polyester, and the content of the fluorocarbon polymer in the liquid crystalline polyester composition is preferably from 0.2 to 10 parts by mass per 100 parts by mass of the liquid crystalline polyester.

The present application claims the priority based on Japanese Patent Application No. 2010-266234 filed on Nov. 30, 2010, under the Paris Convention. A whole of this patent application should be incorporated into the present application by referring to it.

The present invention relates to a liquid crystalline polyester composition which contains a liquid crystalline polyester and mica.

### BACKGROUND OF THE INVENTION

Liquid crystalline polyesters are suitably used as injection-molding materials for use in production of electric and electronic components or parts because of their superior melt flowability and higher heat resistance, strength and rigidity. However, the liquid crystalline polyesters suffer from a problem, because their molecular chains tend to orient in a flow direction during the molding thereof. That is, the problem is that anisotropy tends to occur in contraction and expansion coefficients and mechanical properties of the resultant molded articles. To solve this problem, the addition of mica to the liquid crystalline polyesters has been variously examined (cf., Patent Documents 1 to 8).

### PRIOR ART LITERATURE

### Patent Documents

Patent Document 1: JP-A-03-167252
Patent Document 2: JP-A-04-202558
Patent Document 3: JP-A-04-213354
Patent Document 4: JP-A-2003-321598
Patent Document 5: JP-A-2006-037061
Patent Document 6: JP-A-2006-274068
Patent Document 7: JP-A-2009-108179
Patent Document 8: JP-A-2009-108180

### SUMMARY OF THE INVENTION

The conventional liquid crystalline polyester compositions containing liquid crystalline polyesters and mica can provide molded articles lower in anisotropy, however, suffer from a disadvantage that blisters (or surface expansion) tend to occur in the resultant molded articles when they are exposed to a higher temperature condition for soldering or the like, in case where the liquid crystalline polyester compositions are molded at a higher temperature in order to improve their moldability.

An object of the present invention is therefore to provide a liquid crystalline polyester composition which contains a liquid crystalline polyester and mica and which can provide a molded article hard to form blisters therein under a high temperature condition, even when the liquid crystalline polyester composition is molded at a high temperature.

To achieve this object, the present invention provides a liquid crystalline polyester composition which contains a liquid crystalline polyester, mica and a fluorocarbon polymer having a flow start temperature described below of 330° C. or lower.

That is, the present invention provides the following.

(1) A liquid crystalline polyester composition containing a liquid crystalline polyester, mica and a fluorocarbon polymer whose flow start temperature defined below is 330° C. or lower, wherein the flow start temperature is a temperature at which the fluorocarbon polymer, melted under a load of 9.8 MPa while being heated at a rate of 4° C./min. with a capillary rheometer, shows a viscosity of 4,800 Pa·s when extruded through a nozzle with an inner diameter of 1 mm and a length of 10 mm.
(2) The liquid crystalline polyester composition according to the item (1), wherein the volume-average particle diameter of the mica is from 1 to 100 μm.
(3) The liquid crystalline polyester composition according to the item (1) or (2), wherein the content of the mica is from 15 to 100 parts by mass per 100 parts by mass of the liquid crystalline polyester.
(4) The liquid crystalline polyester composition according to any one of the items (1) to (3), wherein the fluorocarbon polymer is polytetrafluoroethylene having a fluorinated end.
(5) The liquid crystalline polyester composition according to any one of the items (1) to (4), wherein the content of the fluorocarbon polymer is from 0.2 to 10 parts by mass per 100 parts by mass of the liquid crystalline polyester.
(6) A molded article obtained by molding the liquid crystalline polyester composition according to any one of the items (1) to (5).
(7) The molded article according to the item (6), which is a connector.
(8) The molded article according to the item (6) or (7), which has a thin-walled portion with a thickness of 0.1 mm or less.

The flow start temperature means a temperature found as follows: a capillary rheometer is used to melt a fluorocarbon polymer under a load of 9.8 MPa by heating at a rate of 4° C./min., and there is found a temperature at which the melted fluorocarbon polymer shows a viscosity of 4,800 Pa·s when extruded through a nozzle with an inner diameter of 1 mm and a length of 10 mm. This found temperature is defined as the flow start temperature.

The liquid crystalline polyester composition of the present invention can provide a molded article hard to form blisters therein under a high temperature condition, even when it is molded at a high temperature.

### DETAILED DESCRIPTION OF THE PREFERRED EMBODIMENTS

The liquid crystalline polyester for use in the present invention is preferably a liquid crystalline polyester which shows liquid crystallinity in a melted state and which melts at 450° C. or lower. The liquid crystalline polyester may be a liquid crystalline polyester amide, or a liquid crystalline polyester ether, or a liquid crystalline polyester carbonate, or a liquid crystalline polyester imide. The liquid crystalline polyester is preferably a wholly aromatic liquid crystalline polyester obtained by using an aromatic compound alone as a raw material monomer.

Examples of the liquid crystalline polyester include a polyester obtained by polymerizing (or polycondensing) an aromatic hydroxycarboxylic acid, an aromatic dicarboxylic acid, and at least one kind of a compound selected from the group consisting of an aromatic diol, an aromatic hydroxyamine and an aromatic diamine; a polyester obtained by polymerizing plural kinds of aromatic hydroxycarboxylic acids; a polyester obtained by polymerizing an aromatic dicarboxylic acid and at least one kind of a compound selected from the group consisting of an aromatic diol, an aromatic hydroxyamine and an aromatic diamine; and a polyester obtained by polymerizing a polyester such as polyethylene terephthalate, and an aromatic hydroxycarboxylic acid. In this regard, in place of a part or a whole of each of the aromatic hydroxycarboxylic acid, the aromatic dicarboxylic acid, the aromatic diol, the aromatic hydroxyamine and the aromatic diamine, a polymerizable derivative thereof may be used, independently of one another.

Examples of a polymerizable derivative of a compound having a carboxyl group such as the aromatic hydroxycarboxylic acid or the aromatic dicarboxylic acid include an ester obtained by substituting the carboxyl group of the compound with an alkoxycarbonyl group or an aryloxycarbonyl group; an acid halide obtained by substituting the carboxyl group of the compound with a haloformyl group; and an acid anhydride obtained by substituting the carboxyl group of the compound with an acyloxycarbonyl group. Examples of a polymerizable derivative of a compound having a hydroxyl group such as the aromatic hydroxycarboxylic acid, the aromatic diol or the aromatic hydroxyamine include an acylated product obtained by acylating the hydroxyl group of the compound to convert it into an acyloxyl group. Examples of a polymerizable derivative of a compound having an amino group such as the aromatic hydroxyamine or the aromatic diamine include an acylated product obtained by acylating the amino group of the compound to convert it into an acylamino group.

Preferably, the liquid crystalline polyester has a repeating unit of the following formula (1) (hereinafter optionally referred to as “the repeating unit (1)”). More preferably, the liquid crystalline polyester has the repeating unit (1), a repeating unit of the following formula (2) (hereinafter optionally referred to as “the repeating unit (2)”) and a repeating unit of the following formula (3) (hereinafter optionally referred to as “the repeating unit (3)”):

—O—Ar¹—CO— (1)

—CO—Ar²—CO— (2)

—X—Ar³—Y— (3)

In the formulas, Ar¹ represents a phenylene group, a naphthylene group or a biphenylilene group; each of Ar² and Ar³ independently represents a phenylene group, a naphthylene group, a biphenylilene group or a group of the following formula (4); and each of X and Y independently represents an oxygen atom or an imino group (—NH—); and a hydrogen atom in the group represented by Ar¹, Ar² or Ar³ may be independently substituted with a halogen atom, an alkyl group or an aryl group:

—Ar⁴—Z—Ar⁵— (4)

wherein each of Ar⁴ and Ar⁵ independently represents a phenylene group or a naphthylene group; and Z represents an oxygen atom, a sulfur atom, a carbonyl group, a sulfonyl group or an alkylidene group.

Examples of the halogen atom include a fluorine atom, a chlorine atom, a bromine atom and an iodine atom. Examples of the alkyl group include a methyl group, an ethyl group, a n-propyl group, an isopropyl group, a n-butyl group, an isobutyl group, a s-butyl group, a t-butyl group, a n-hexyl group, a 2-ethylhexyl group, a n-octyl group and a n-decyl group, wherein the number of carbon atoms in the alkyl group is usually from 1 to 10. Examples of the aryl group include a phenyl group, an o-tolyl group, a m-tolyl group, a p-tolyl group, a 1-naphtyl group, and a 2-naphthyl group, wherein the number of carbon atoms in the aryl group is usually from 6 to 20. When the hydrogen atom in the group represented by Ar¹, Ar² or Ar³ is substituted with any of these groups, the number of substituent groups is usually 2 or less, preferably 1 or less, independently per each group represented by Ar¹, Ar² or Ar³.

Examples of the alkylidene group include a methylene group, an ethylidene group, an isopropylidene group, a n-butylidene group and a 2-ethylhexylidene group, wherein the number of carbon atoms in the alkylidene group is usually from 1 to 10.

The repeating unit (1) is a repeating unit derived from a predetermined aromatic hydroxycarboxylic acid. As the repeating unit (1), a repeating unit of the formula (1) in which Ar¹ is a p-phenylene group (a repeating unit derived from p-hydroxybenzoic acid) and a repeating unit of the formula (1) in which Ar¹ is a 2,6-naphthylene group (a repeating unit derived from 6-hydroxy-2-naphthoic acid) are preferred.

The repeating unit (2) is a repeating unit derived from a predetermined aromatic dicarboxylic acid. As the repeating unit (2), a repeating unit of the formula (2) in which Ar² is a p-phenylene group (a repeating unit derived from terephthalic acid), a repeating unit of the formula (2) in which Ar² is a m-phenylene group (a repeating unit derived from isophthalic acid), a repeating unit of the formula (2) in which Ar² is a 2,6-naphtylene group (a repeating unit derived from 2,6-naphthalenedicarboxlic acid), and a repeating unit of the formula (2) in which Ar² is a diphenylether-4,4′-diyl group (a repeating unit derived from diphenylether-4,4′-dicarboxlic acid) are preferred. As the repeating unit (2), a repeating unit of the formula (2) in which Ar² is a p-phenylene group (a repeating unit derived from terephthalic acid) and a repeating unit of the formula (2) in which Ar² is a m-phenylene group (a repeating unit derived from isophthalic acid) are more preferred.

The repeating unit (3) is a repeating unit derived from a predetermined aromatic diol, aromatic hydroxyl amine or aromatic diamine. As the repeating unit (3), a repeating unit of the formula (3) in which Ar³ is a p-phenylene group (a repeating unit derived from hydroquinone, p-aminophenol or p-phenylenediamine) and a repeating unit of the formula (3) in which Ar³ is a 4,4′-biphenylilene group (a repeating unit derived from 4,4′-dihydroxybiphenyl, 4-amino-4′-hydroxybiphenyl or 4,4′-diaminobiphenyl) are preferred.

A content of the repeating unit (1) is usually 30% by mol or more, preferably from 30 to 80% by mol, more preferably from 40 to 70% by mol, still more preferably from 45 to 65% by mol, based on a total amount of all the repeating units, which is calculated as follows: the mass of each of the repeating units constituting the liquid crystalline polyester is divided by the formula weight of each of the repeating units to find a substantial amount (mol) of the molar number of each of the repeating units, and the found substantial amounts of the respective repeating units are added to obtain the sum thereof which is defined as the above total amount of all the repeating units. A content of the repeating unit (2) is usually 35% by mol or less, preferably from 10 to 35% by mol, more preferably from 15 to 30% by mol, still more preferably from 17.5 to 27.5% by mol, based on the total amount of all the repeating units. A content of the repeating unit (3) is usually 35% by mol or less, preferably from 10 to 35% by mol, more preferably from 15 to 30% by mol, still more preferably from 17.5 to 27.5% by mol, based on the total amount of all the repeating units. With increase of the content of the repeating unit (1), the melt-flowability, heat resistance, strength and rigidity of the resultant liquid crystalline polyester tend to increase. However, too large a content of the repeating unit (1) is more likely to raise a melting temperature and a melt viscosity of the liquid crystalline polyester, which may lead to elevation in temperature required for molding.

A ratio of the content of the repeating unit (2) to the content of the repeating unit (3) (i.e., the content of the repeating unit (2)/the content of the repeating unit (3)) (mol/mol) is usually from 0.9/1 to 1/0.9, preferably from 0.95/1 to 1/0.95, more preferably from 0.98/1 to 1/0.98.

In this regard, the liquid crystalline polyester may contain two or more kinds selected from the repeating units (1) to (3). Further, the liquid crystalline polyester may contain a repeating unit other than the repeating units (1) to (3). In this case, a content of the repeating unit other than the repeating units (1) to (3) is usually 10% by mol or less, preferably 5% by mol or less, based on the total amount of all the repeating units.

Preferably, the repeating unit (3) in the liquid crystalline polyester has oxygen atoms as the respective groups X and Y. In other words, preferably, the liquid crystalline polyester has the repeating unit (3) derived from a predetermined aromatic diol, because the melt viscosity of the liquid crystalline polyester is more likely to lower. More preferably, the repeating unit (3) has oxygen atoms alone as the respective groups X and Y.

Preferably, the liquid crystalline polyester is produced by a method of polymerizing raw material monomer(s) in molten state(s) corresponding to the constitutive repeating unit(s) to obtain a polymer (or a prepolymer), and polymerizing the prepolymer in a solid state. By this method, a high-molecular liquid crystalline polyester improved in heat resistance, strength and rigidity can be produced at a higher operating efficiency. The melt-state polymerization may be carried out in the presence of a catalyst. Examples of this catalyst include metal compounds such as magnesium acetate, tin (I) acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among those, the nitrogen-containing heterocyclic compounds are preferably used.

The flow start temperature of the liquid crystalline polyester is usually 270° C. or higher, preferably from 270 to 400° C., more preferably from 280 to 380° C. The higher flow start temperature tends to improve the heat resistance, strength and rigidity of the resultant liquid crystalline polyester. However, too high a flow start temperature tends to lead to a higher melting temperature and a higher melt viscosity. Consequently, a temperature required for molding such a liquid crystalline polyester tends to be higher.

The flow start temperature is also called a flow temperature and is determined as follows: a capillary rheometer is used to melt the liquid crystalline polyester under a load of 9.8 MPa (100 kg/cm²) by heating at a rate of 4° C./min., and a temperature at which the melted liquid crystalline polyester shows a viscosity of 4,800 Pa·s (48,000 poise) when it is extruded through a nozzle with an inner diameter of 1 mm and a length of 10 mm is defined as the flow start temperature. This temperature can be used as an index for the molecular weight of the liquid crystalline polyester (refer to page 95 of “Synthesis, Molding and Application of Liquid Crystal Polymer” edited by Naoyuki Koide, and published by CMC INC. on Jun. 5, 1987).

The liquid crystalline polyester composition of the present invention contains a fluorocarbon polymer having a flow start temperature of 330° C. or lower. By adding the low-molecular fluorocarbon polymer having a flow start temperature below a predetermined temperature, in addition to the mica, to a liquid crystalline polyester, there can be obtained a liquid crystalline polyester composition which can provide a molded article hard to form blisters therein under a high temperature condition, even when it is molded at a high temperature. In case where a liquid crystalline polyester composition containing a liquid crystalline polyester and mica is molded at a high temperature, the mica accelerates decomposition of the liquid crystalline polyester to facilitate generation of a gas. This gas is incorporated into the molded article and is not drawn out therefrom and thus is retained therein. When the molded article is exposed to a high temperature condition thereafter, the gas is expanded to raise the surface of the molded article to thereby facilitate occurrence of blisters therein. However, the addition of the above-specified fluorocarbon polymer to the liquid crystalline polyester composition produces the following effect. That is, the fluorocarbon polymer shows excellent flowability during the melt-kneading thereof and excellent dispersibility in the liquid crystalline polyester, so that the fluorocarbon polymer disturbs a highly gas-barriering skin layer on the surface of the molded article. As a result, the gas is hard to retain in the molded article, and consequently, blisters are hard to form in the molded article, even when the molded article is exposed to a high temperature condition.

The flow start temperature of the fluorocarbon polymer is found as follows: a capillary rheometer is used to melt the fluorocarbon polymer under a load of 9.8 MPa (100 kg/cm²) by heating at a rate of 4° C./min.; and there is found a temperature at which the melted fluorocarbon polymer shows a viscosity of 4,800 Pa·s (48,000 poise) when it is extruded through a nozzle with an inner diameter of 1 mm and a length of 10 mm. This temperature is used as an index for the molecular weight of the fluorocarbon polymer.

Examples of the mica include phlogopite, muscovite, sericite, fluoro-phlogopite, tetrasilicic potassium mica, tetrasilicic sodium mica, Na taeniolite and Li taeniolite. Among those, phlogopite and muscovite are preferable because of their superior electrical insulating properties and heat resistance. The mica may be produced by a wet pulverizing method or a dry pulverizing method, while the mice produced by the wet pulverizing method is preferable because of its narrow particle diameter distribution and uniform particle diameters.

A volume-average particle diameter of the mica is preferably from 10 to 100 μm, more preferably from 20 to 50 μm. When the mica has too small an average particle diameter, the resultant liquid crystalline polyester composition tends to hang from the nozzle when the liquid crystalline polyester composition is molded, and thus is hard to be molded. When the mica has too large an average particle diameter, it becomes hard to lessen anisotropy of the resultant molded article, so that the molded article tends to warp. The volume-average particle diameter of the mica can be measured by laser diffractometry.

A content of the mica in the liquid crystalline polyester composition is preferably from 15 to 100 parts by mass, more preferably from 20 to 50 parts by mass, per 100 parts by mass of the liquid crystalline polyester. Too small a content of the mica makes it hard to lessen anisotropy of the molded article and permits the molded article to warp, while too large a content of the mica tends to lower the flowability of the liquid crystalline polyester composition during the molding thereof. Consequently, molding of the liquid crystalline polyester composition becomes hard.

The fluorocarbon polymer may be a homopolymer or a copolymer of fluorocarbon, or a mixture thereof. Examples of polyfluorocarbon include polytetrafluoroethylene, a tetrafluoroethylene-hexafluoropropylene copolymer, polytrichlorofluoroethylene and a tetrafluoroethylene-perfluoroalkylvinylether copolymer. Among those, polytetrafluoroethylene is preferred, and polytetrafluoroethylene having a fluorinated end is more preferred.

As described above, the flow start temperature of the fluorocarbon polymer is 330° C. or lower. A flow start temperature lower than this temperature makes it hard to produce a blister-reducing effect in the molded article under a high temperature condition. The flow start temperature of the fluorocarbon polymer is preferably 225° C. or higher, more preferably 265° C. or higher. Too low a flow start temperature tends to lower the strength of the liquid crystalline polyester composition.

A content of the fluorocarbon polymer in the liquid crystalline polyester composition is preferably from 0.2 to 10 parts by mass, more preferably from 0.2 to 5 parts by mass, per 100 parts by mass of the liquid crystalline polyester. Too small a content of the fluorocarbon polymer makes it hard to produce the effect of the fluorocarbon polymer, while too large a content thereof tends to lower the moldability and strength of the liquid crystalline polyester composition.

The liquid crystalline polyester composition may contain at least one other component such as a filler other than the mica, or an additive, or a resin other than the liquid crystalline polyester and the fluorocarbon polymer.

The filler may be a fibrous filler, a plate-like filler other than the mica, or a globular or other particulate filler other than the fibrous and plate-like fillers. The filler may be an inorganic filler or an organic filler. Examples of a fibrous inorganic filler include glass fibers; carbon fibers such as PAN type carbon fibers and pitch type carbon fibers; ceramic fibers such as silica fibers, alumina fibers and silica-alumina fibers; and metal fibers such as stainless steel fibers. Examples of a fibrous inorganic filler also include whiskers such as potassium titanate whiskers, barium titanate whiskers, wollastonite whiskers, aluminum borate whiskers, silicon nitride whiskers and silicon carbide whiskers. Examples of a fibrous organic filler include polyester fibers and aramid fibers. Examples of the plate-like inorganic filler other than the mica include talc, graphite, wollastonite, glass flakes, barium sulfate and calcium carbonate. Examples of the particulate inorganic filler include silica, alumina, titanium oxide, glass beads, glass balloons, boron nitride, silicon carbide and calcium carbonate. A content of the filler other than the mica is usually from 0 to 100 parts by mass per 100 parts by mass of the liquid crystalline polyester.

Examples of the additive include an antioxidant, a thermal stabilizer, a UV absorber, an antistatic agent, a surfactant, a flame retardant and a coloring agent. A content of the additive is usually from 0 to 5 parts by mass per 100 parts by mass of the liquid crystalline polyester.

Examples of the resin other than the liquid crystalline polyester and the fluorocarbon polymer include thermoplastic resins other than liquid crystalline polyesters and the fluorocarbon polymer, such as polypropylene, polyamide, polyester other than the liquid crystalline polyester, polysulfone, polyphenylene sulfide, polyether ketone, polycarbonate, polyphenylene ether and polyetherimide; and thermosetting resins such as a phenol resin, an epoxy resin, a polyimide resin and a cyanate resin. A content of the resin other than the liquid crystalline polyester and the fluorocarbon polymer is usually from 0 to 20 parts by mass per 100 parts by mass of the liquid crystalline polyester.

Preferably, the liquid crystalline polyester composition is prepared by melt-kneading the liquid crystalline polyester, the mica and the fluorocarbon polymer, and optionally other component, using an extruder; and extruding the knead-mixture into pellets. As the extruder, there is preferably used an extruder which comprises a cylinder, at least one screw provided in the cylinder and at least one supply port provided in the cylinder. More preferably, such an extruder has at least one vent portion provided in the cylinder. A decompression degree at the vent portion is preferably −0.06 MPa or lower in terms of a gauge pressure.

The liquid crystalline polyester composition of the present invention, thus obtained, can provide a molded article hard to form blisters therein under a high temperature condition, even if it is molded at a high temperature. The method for molding the liquid crystalline polyester composition is preferably a melt-molding method. Examples of the melt-molding method include extrusion-molding methods such as an injection-molding method, a T-die method and an inflation method; a compression molding method; a blow molding method; a vacuum molding method; and a press molding method. Among those, the injection molding method is preferred.

Examples of products or parts or components which are the molded articles as obtained above include bobbins such as optical pickup bobbins and bobbins for transformers; relay parts such as relay cases, relay bases, relay spools and relay armatures; connectors such as RIMM, DDR, CPU sockets, S/O, DIMM, board-to-board connectors, FPC connectors and card connectors; reflectors such as lamp reflectors and LED reflectors; holders such as lamp holders and heater holders; vibration plates such as speaker vibration plates; separation claws such as separation claws for use in copying machines and printers; camera module parts; switch parts; motor components; sensor parts; parts of hard disc drives; tableware such as ovenware; parts or components of vehicles; parts or components of aircraft; and sealing members such as sealing members for semiconductor devices and coils.

Especially, the liquid crystalline polyester composition of the present invention is suitable to use as materials for connectors, such as CPU sockets, which may be exposed to a high temperature condition due to soldering or the like. This is because the liquid crystalline polyester composition can provide molded articles which are hard to form blisters therein under a high temperature condition, even when it is molded into molded articles having thin-walled portions or molded articles having complicated configurations at a high temperature. In addition, the liquid crystalline polyester composition is suitable to use as a material for a molded article having a thin-walled portion with a thickness of 0.1 mm or less, which may be needed to be shaped at a high temperature.

### EXAMPLES

### Measurement of Flow Start Temperature of Liquid Crystalline Polyester

About 2 g of a liquid crystalline polyester was charged in a cylinder equipped with a die having a nozzle with an inner diameter of 1 mm and a length of 10 mm and was melted under a load of 9.8 MPa (100 kg/cm²) while being heated at a rate of 4° C./min.; and the melted liquid crystalline polyester was then extruded through the nozzle to measure a temperature at which the melted liquid crystalline polyester showed a viscosity of 4,800 Pa·s (48,000 poise), with a flow tester (“CFT-500 Model” manufactured by SHIMADZU CORPORATION).

### Measurement of Flow Start Temperature of Fluorocarbon Polymer

A flow start temperature of a fluorocarbon polymer was measured in the same manner as in the measurement of the liquid crystalline polyester. That is, about 2 g of the fluorocarbon polymer was charged in a cylinder equipped with a die having a nozzle with an inner diameter of 1 mm and a length of 10 mm and was melted under a load of 9.8 MPa (100 kg/cm²) while being heated at a rate of 4° C./min.; and the melted fluorocarbon polymer was then extruded through the nozzle to measure a temperature at which the melted fluorocarbon polymer showed a viscosity of 4,800 Pa·s (48,000 poise), with the flow tester (“CFT-500 Model” manufactured by SHIMADZU CORPORATION).

### Examples 1 to 4 and Comparative Examples 1 to 3

### Production of Liquid Crystalline Polyester (1)

A reactor equipped with a stirrer, a torque meter, a nitrogen gas-introducing tube, a thermometer and a reflux condenser was charged with 994.5 g (7.2 mol) of p-hydroxybenzoic acid, 299.0 g (1.8 mol) of terephthalic acid, 99.7 g (0.6 mol) of isophthalic acid, 446.9 g (2.4 mol) of 4,4′-dihydroxybiphenyl and 1,347.6 g (13.2 mol) of acetic anhydride. Then, the gas in the reactor was replaced by a nitrogen gas and 0.18 g of 1-methylimidazole was charged in the reactor. The resulting mixture in the reactor was heated from a room temperature to 150° C. in 30 minutes while being stirred under a stream of the nitrogen gas. Then, the mixture was allowed to reflux at 150° C. for 30 minutes. Then, 2.4 g of 1-methylimidazole was added, and the mixture was heated from 150° C. to 320° C. over 2 hours and 50 minutes while by-produced acetic acid and non-reacted acetic anhydride were distilled off. At a point of time when increase in torque was observed, the content was removed from the reactor and was then cooled to a room temperature. The resulting solid was pulverized with a grinder, and the resulting powder was heated from the room temperature to 250° C. in one hour and was further heated from 250° C. to 295° C. over 5 hours and was maintained at 295° C. for 3 hours, under a nitrogen atmosphere, for solid phase polymerization of the powder. After that, the resulting powdery product was cooled to obtain a powdery liquid crystalline polyester (1). The flow start temperature of this liquid crystalline polyester (1) was 327° C.

### Production of Liquid Crystalline Polyester (2)

A reactor equipped with a stirrer, a torque meter, a nitrogen gas-introducing tube, a thermometer and a reflux condenser was charged with 994.5 g (7.2 mol) of p-hydroxybenzoic acid, 239.2 g (1.44 mol) of terephthalic acid, 159.5 g (0.96 mol) of isophthalic acid, 446.9 g (2.4 mol) of 4,4′-dihydroxybiphenyl and 1,347.6 g (13.2 mol) of acetic anhydride. Then, the gas in the reactor was replaced by a nitrogen gas and 0.18 g of 1-methylimidazole was charged in the reactor. The resulting mixture in the reactor was heated from a room temperature to 150° C. in 30 minutes while being stirred under a stream of the nitrogen gas. Then, the mixture was allowed to reflux at 150° C. for 30 minutes. Then, 2.4 g of 1-methylimidazole was added, and the mixture was heated from 150° C. to 320° C. over 2 hours and 50 minutes while by-produced acetic acid and non-reacted acetic anhydride were distilled off. At a point of time when increase in torque was observed, the content was removed from the reactor and was then cooled to a room temperature. The resulting solid was pulverized with a grinder, and the resulting powder was heated from the room temperature to 220° C. in one hour and was further heated from 220° C. to 240° C. in 30 minutes and was maintained at 240° C. for 10 hours, under a nitrogen atmosphere, for solid phase polymerization of the powder. After that, the resulting powdery product was cooled to obtain a powdery liquid crystalline polyester (2). The flow start temperature of this liquid crystalline polyester (2) was 286° C.

### Mica

As the mica, “AB25S” with a volume-average particle diameter of 21 μm manufactured by YAMAGUCHI MICA CO., LTD. was used. The volume-average particle diameter was measured by laser diffractometry.

### Fluorocarbon Polymer

As the fluorocarbon polymer, the following polymers were used:
Fluorocarbon polymer (1): “CEFRAL LUBE I” manufactured by Central Glass Co., Ltd. Flow start temperature: 328° C.
Fluorocarbon polymer (2): “LUBRON L5” manufactured by DAIKIN INDUSTRIES, LTD. Flow start temperature: 349° C.

### Preparation of Liquid Crystalline Polyester Composition

One hundred parts by mass of each liquid crystalline polyester, the mica in the amount indicated in Table 1, and the fluorocarbon polymer of the kind and in the amount indicated in Table 1 were mixed, and then, the resulting mixture was pelletized at a cylinder temperature of 340° C. by the use of a twin-screw extruder (“PCM-30” manufactured by Ikegai Corp.) to obtain a pellet-like liquid crystalline polyester composition.

### Evaluation of Heat Resistance Against Soldering

The liquid crystalline polyester composition was molded into dumbbell specimens with a thickness of 1.2 mm according to JIS K7113 (1/2) at a cylinder temperature of 350° C. or 370° C. and a mold temperature of 130° C. and at a injection rate of 75 mm/sec. by the use of an injection molding machine (“PS40E5ASE Model” manufactured by Nissei Plastic Industrial Co., Ltd.). Out of these specimens, 10 specimens were immersed in a bath of molten solder heated to 280° C. for 60 seconds and were then removed therefrom. After that, occurrence of blisters in the surface of each specimen was observed. The results are shown in Table 1.

TABLE 1

| | | | Example | | | | | | |
|---|---|---|---|---|---|---|---|---|---|
| | | | Ex. 1 | Ex. 2 | Ex. 3 | Ex. 4 | C. Ex. 1 | C. Ex. 2 | C. Ex. 3 |
| Liquid | (1) | part by mass | 55 | 55 | 55 | 55 | 55 | 55 | 55 |
| crystalline | (2) | part by mass | 45 | 45 | 45 | 45 | 45 | 45 | 45 |
| polyester | | | | | | | | | |
| Mica | | part by mass | 42.9 | 33.3 | 42.9 | 42.9 | 42.9 | 33.3 | 33.3 |
| Fluorocarbon | (1) | part by mass | 1.4 | 1.3 | 0.7 | 0.3 | — | — | — |
| polymer | (2) | part by mass | — | — | — | — | — | — | 1.4 |

| | | | | | | | | |
|---|---|---|---|---|---|---|---|---|
| Heat resistance to | Cylinder temp. of | 0 | 0 | 0 | 0 | 0 | 0 | 0 |
| soldering | 350° C. | | | | | | | |
| Blisters (number) | Cylinder temp. of | 0 | 0 | 4 | 8 | 10 | 10 | 10 |
| | 370° C. | | | | | | | |

1. A liquid crystalline polyester composition containing a liquid crystalline polyester, mica and a fluorocarbon polymer whose flow start temperature defined below is 330° C. or lower, wherein the flow start temperature is a temperature at which the fluorocarbon polymer, melted under a load of 9.8 MPa while being heated at a rate of 4° C./min with a capillary rheometer, shows a viscosity of 4,800 Pa·s when extruded through a nozzle with an inner diameter of 1 mm and a length of 10 mm.

2. The liquid crystalline polyester composition according to claim 1, wherein the volume-average particle diameter of the mica is from 1 to 100 μm.

3. The liquid crystalline polyester composition according to claim 1, wherein the content of the mica is from 15 to 100 parts by mass per 100 parts by mass of the liquid crystalline polyester.

4. The liquid crystalline polyester composition according to claim 1, wherein the fluorocarbon polymer is polytetrafluoroethylene having a fluorinated end.

5. The liquid crystalline polyester composition according to claim 1, wherein the content of the fluorocarbon polymer is from 0.2 to 10 parts by mass per 100 parts by mass of the liquid crystalline polyester.

6. A molded article obtained by molding the liquid crystalline polyester composition according to claim 1.

7. The molded article according to claim 6, which is a connector.

8. The molded article according to claim 6, which has a thin-walled portion with a thickness of 0.1 mm or less.
